(19) United States
(12) Patent Application Publication
(10) Pub. No.: US 2008/0097762 A1
(43) Pub. Date: Apr. 24, 2008

(54) Multicultural and Multimedia Data Collection and Documentation Computer System, Apparatus and Method

(76) Inventors: Linda H. Kunz, Cedarburg, WI (US); Chad J. Berkan, Waukesha, WI (US); Benjamin R. Sier, Waukesha, WI (US)

Correspondence Address: JOSEPH S. HEINO, ESQ.;DAVIS & KUELTHAU, S.C., 111 E. KILBOURN, SUITE 1400, MILWAUKEE, WI, 53202-6613, US

(21) Appl. No.: 11/722,148

(22) PCT Filed: Dec. 21, 2004
(86) PCT No.: PCT/US04/43177

§ 371 Date: Jun. 19, 2007

(51) Int. Cl. G10L 21/06

(52) U.S. Cl. 704/276; 704/E15.045

(57) ABSTRACT

A computer system apparatus and method uses a display (20) to present a query (40, 50, 60) and responses (41-45) to the query (40, 50, 60) in a first language. The user may select the most appropriate response (41-45) to the given query (40, 50, 60) or may select a change of the written language for the responses (41-45) presented by touching button (70) such that the same responses (41-45) are presented in a second or other language. The display (20) also allows the user to select a verbalization of the responses (41-45) in the first, second or other language by touching button (80). The display (20) further allows the user to view an animated or video vignette display that represents the meaning of the responses (41-45) that are displayed and/or verbalized by touching button (90), whereby the user's understanding of the responses (41-45) is enhanced.

### FIELD OF THE INVENTION

The present invention relates generally to the field of computers peripheral computer devices and software methods that enable user interaction with computers, particularly of the type where data and information is collected and documented. More particularly, it relates to a multicultural and multimedia data collection and documentation computer system and input apparatus that allows the user to augment printed display text with electronically stored data in the form of text presented in other languages, verbalization of the text, and/or video images that are relevant to the message being conveyed by the text.

### BACKGROUND OF THE INVENTION

One reality of our modern age is that computers are invaluable tools, found literally everywhere as their use continues to proliferate and permeates most aspects of human society. This proliferation is driven, in large part, by the public's enthusiasm for computer-based applications that are used as sources of personal convenience and entertainment in the home and at leisure, as well as by competitive initiatives from governments and businesses to increase automation and enhance work-product, in terms of both speed and accuracy. There is also the notion that we may, eventually, succeed in becoming a “paperless” society, a goal long-sought by those who tout the virtues of the computer.

Another reality of our modern age is that people are becoming increasingly mobile in terms of where they live and where they work. This phenomenon is not only regional, but intercontinental. In the situation of the job market in the United States, many traditionally lower-paying jobs are assumed by persons who have migrated to the United States for one reason or another and who do not have a firm, or even any, grasp of the English language. Such positions are still vitally important to the industry in which they exist and so must be filled by persons who can perform the job, their language skills notwithstanding. Accordingly, there is increasing pressure to make sure that our workplaces and virtually every other aspect of human life are tolerant of and, to the extent possible, customized to the multicultural reality of persons who come from different places around the globe and who speak different languages, and who even speak different dialects within a language.

The printed word, or many words in the form of a textual work, has long been scribed, written or printed onto a tangible media. Once printed in this fashion, the written word generally is not, nor can it be, readily changed. That printed work is available for all to see. If the printed work is written in English, for example, it is there for reading by any and all persons who are familiar with the English language. Without a translation, however, the printed work is essentially unintelligible to those whose native, or first, written language is other than English. In this situation, the written word is nothing more than a score of meaningless symbols arranged in a generally linear fashion.

Comprehension of a textual work is further subject to the inherent shortcomings of the written word. In the English language, for example, different words have different meanings, and sometimes the same word itself has different meanings. To further diminish comprehension, words that sound the same are often spelled differently, and vice versa. In short, the spoken word can be subject to similar problems of interpretation as is the written word, depending upon the situation, and even by the most expert linguists. For the most part, every language has these inherent problems which affect both visual and verbal understanding of words and phrases. As mentioned above, the problem is made even more complex for persons who are exposed to a language that is not their first or native language.

On the other hand, it is possible to enhance understanding of the written word by providing a translation of those words to a first or native language, or even to a language that is slightly more familiar to the reader. Even better, where verbalizations and intonations can also affect the meaning of the written word, such as in Mandarin Chinese for example, understanding of the written word can be further enhanced by an audio-perceptible version of the written word. Better still, is a situation where the written and verbalized message is presented in an animated or video vignette display that represents or recreates a universally understood action or human reaction, which reinforces understanding and gives credence to the adage that “a picture is worth a thousand words.” In the art of computers, the realization of these shortcomings in communication are no less significant and may even be more so.

As a basic premise, a complete computer system generally requires the addition of control units, input devices, storage devices, an operating system, and output devices. Input devices are peripheral devices that generate input for the computer system and include such devices as a keyboard, a track-ball, a “mouse,” a hand-guided device which when moved on a flat surface moves the cursor on a computer display screen, and other like devices. For example, there are many applications where computer input, or the access of stored information, is effected by use of a touch sensitive display device, or “touch screen” that senses tactile contact by a user or by a stylus that is held by the user. Although touch screens are relatively new, they are, by today's standards, old in the art of peripheral computer devices. In the typical touch screen, the user is provided with a screen display that may have one or more indicia, words or icons situated within a “region” of the display and that the user may “touch” to access information represented by that index, word or icon. Upon touching the index, word or icon, the screen display changes and may present further touch screen options, and so on. It is also recognized by these inventors that display technology continues to advance into the areas of digital screen films and “smart paper,” a material that has the look and feel of thick stock paper but which is actually a controllable display surface. Collectively, any such device and any conventional monitor or display screen shall be referred to in this disclosure simply as a “display.”

In the view of these inventors, what is needed is a display that presents multiple words or phrases from which the user may select the most appropriate choice for a given situation. This broad concept will be more apparent later in the detailed description where a preferred embodiment of the system, input apparatus and method of the present invention is specifically applied to an intended use, i.e. the entry of data onto an electronic form, which form, once populated, is used to electronically transmit the entered and collected data and information, or portions of it, to others.

What is also needed is a display that allows the user to select a change from the written language for the words or phrases that are displayed to that of another written language to enhance the user's comprehension of the display. What is also needed is a display that further allows the user to select a verbalization of that portion of the written language, and in the chosen language that is being displayed, to still further enhance the user's understanding as to what the display, or a discrete part of the display, is telling the user in the written form. That is, the user can both read and hear the words or phrases that are being displayed.

What is also needed is a display that still further allows the user to select an animation or video vignette that represents, in essentially “universal language” form, a display for the written and/or verbalized words which even further enhances the user's comprehension as to what the display, or a discrete part of the display, is telling the user. In summary, the user has the potential of accessing the written word, a verbalization of the written word, and in any language, together with an active visual display of the message being conveyed in a form other than that of the written word. Such capability can and, in the view of these inventors, does enhance comprehension and understanding of the message that the display is intended to convey, making the user's response to that message more meaningful and accurate regardless of the cultural and lingual background of the user.

### SUMMARY OF THE INVENTION

Accordingly, a primary object of the present invention is to provide a new, useful and non-obvious computer system, input apparatus and method for facilitating the use of a display in a way that presents multiple words or phrases in a first language and from which the user may select the most appropriate word or phrase in response to the given query. Another object of the present invention is to provide such a system, input apparatus and method wherein the user can also select a change of the written language for the words or phrases presented such that the same words or phrases are presented in a second or other language, but having essentially the same meaning wherein the user's comprehension is enhanced. Another object of the present invention is to provide such a system, input apparatus and method whereby the display allows the user to select a verbalization and enunciation of the words or phrases in the first, second or other language. Yet another object of the present invention is to provide such a system, input apparatus and method whereby the display also enables the user to view an animated or video vignette display that represents the meaning of the words or phrases whereby the user's understanding of the words or phrases is further enhanced. Still another object of the present invention is to provide such a system, apparatus and method whereby multicultural considerations are minimized and whereby the inputted information is entered in a more consistent manner, regardless of the cultural and lingual background of the input user.

In accordance with the aforementioned objectives of the present invention, there is provided a computer system, input apparatus and method that uses a display to present a query and multiple words or phrases in response to the query in a first language. The user may select the most appropriate word or phrase in response to the given query or may select a change of the written language for the words or phrases presented such that the same words or phrases are presented in a second or other language. The display also allows the user to select a verbalization and enunciation of the words or phrases in the first, second or other language, which verbalization can be played audibly over a sound generating speaker or similar peripheral device. The display also enables the user to view an animated or video vignette display that represents the meaning of the words or phrases displayed and/or verbalized whereby the user's understanding of the words or phrases is further enhanced. This apparatus and method minimizes multicultural considerations which results in the input of information by the user that is more consistent, meaningful.

One preferred embodiment of the system, apparatus and method is provided for the entry of data onto an electronically-generated form, the form having multiple points of consideration. The form is displayed, for example, on a touch screen. Each point of consideration poses a question or query, to be answered appropriately by the input user. When the user touches the relevant point of consideration, the view of that point is maximized such that the user can focus on that point of consideration. The question or query requires the user to select one of a plurality of possible answers to the query. The answers are pre-programmed and presented as a finite number of possible answers to the query. In the preferred embodiment, the form is a Minimum Data Set (MDS) collection form that is used for nursing home resident assessment and care screening, which form is presented in the English language and assumes the electronic configuration of a form that asks for information that is mandated by Medicare for proper patient reporting and provider reimbursement. The MDS includes a plurality of patient-sensitive considerations including, for example, observation and rating of patient difficulties or assistance needed to perform life-sustaining Activities of Daily Living (ADL), patient communication/hearing patterns, mood and behavior patterns, physical functioning and structural problems, special treatments, and so on. Each consideration presents a plurality of possible responses and the user populates each specific consideration with an appropriate response. As each consideration is presented to the user, the user may choose a given response. If the user's first language is not English, the user may touch the screen at a point to re-generate the display options in another language. If the user is still tentative about a particular response, the user can touch the screen at another point to have one or more of the response options verbalized by means of a speaker. If, after verbalization, the user continues to be tentative, the user can touch another point on the screen to have an animated video vignette displayed on the screen which will explain one or more of the response options. For example, if the query was generally directed to “mood and behavior patterns” and particularly directed to “behavioral symptoms”, the user may observe a video vignette that displays “physically abusive behavioral symptoms” to observe a representative scenario wherein that type of behavior is being displayed by the patient. Armed with a better understanding of the options available, the user enters the appropriate choice and moves on to the next area of inquiry. Once the electronic form is properly and fully populated, the data, or certain portions of the data, contained within it may be stored and/or forwarded, for example, to other healthcare providers, to healthcare insurers or to Medicare for patient reimbursement purposes. By taking a multicultural and multimedia approach to this type of data gathering, the gathered information is more accurate and consistent and, thus, more useful and valuable to those who must use the information for various purposes.

The foregoing and other features of the system, apparatus and method of the present invention will be apparent from the detailed description that follows.

### BRIEF DESCRIPTION OF THE DRAWINGS

FIG. 1 is a computer touch screen display illustrating a data entry form in electronic format in accordance with a preferred embodiment of the present invention and showing the multiple language selection buttons, the audio play button and the video play button.

FIG. 2 is the computer touch screen display as shown in FIG. 1 following selection of a given query area, the query area being maximized.

FIG. 3 is the computer touch screen display following selection of one of the alternative language buttons.

FIG. 4 is the computer touch screen display following selection of the video play button for a given query response.

### DETAILED DESCRIPTION

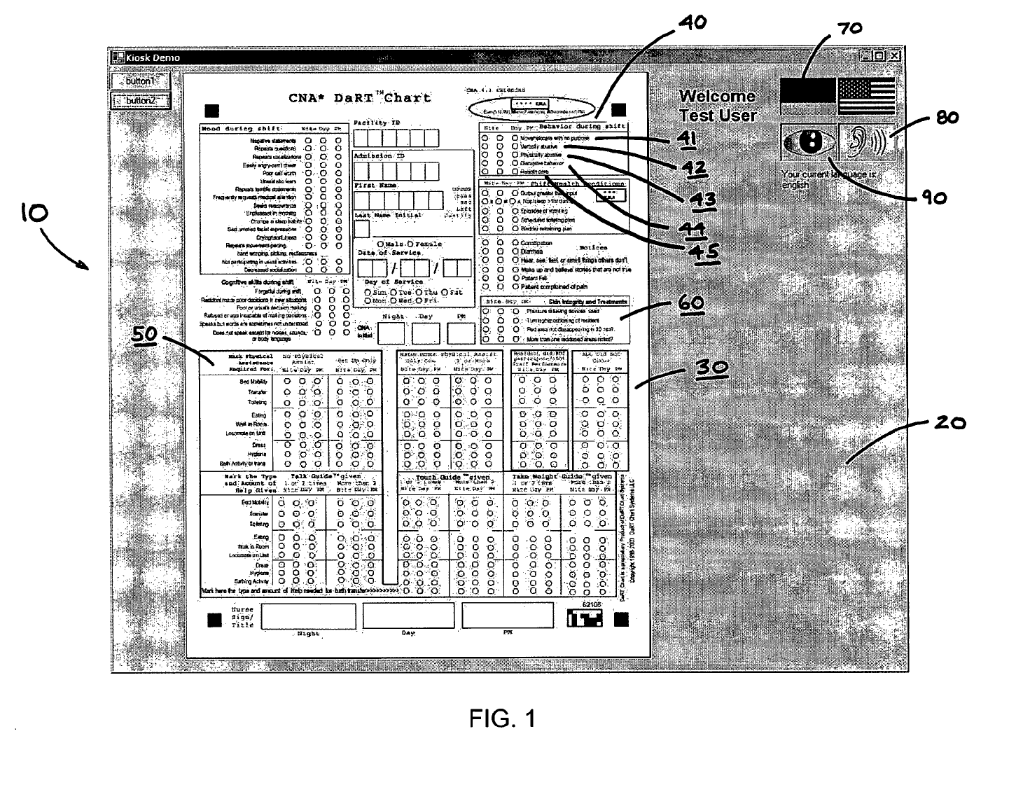

Referring now to the drawings in detail, wherein like numbered elements refer to like elements throughout, FIGS. 1 through 4 illustrate a touch screen display, generally identified 10, that is used in accordance with the present invention. As alluded to earlier, it is to be understood that the system, apparatus and method of the present invention is not limited to any one particular type of peripheral input device or display device. That is, the input device could include a touch screen display, a keyboard, a track-ball, a mouse, a stylus, or any other similar device of current of future intended use. Any such device may be used without deviating from the scope of the present invention.

The present invention provides, in general terms, a computer system and method that uses an input apparatus in the form of a touch screen 10 to present a screen display 20 that includes at least one query and multiple words or phrases in response to that query in a first language. The user may select the most appropriate word or phrase in response to the given query or may select a change of the written language for the words or phrases presented such that the same words or phrases are presented in a second or other language. The screen display 20 also allows the user to select a verbalization and enunciation of the words or phrases in the first, second or other language. The screen display 20 also enables the user to view an animated or video vignette display that represents the meaning of the words or phrases displayed and/or verbalized whereby the user's understanding of the words or phrases is further enhanced. This system and method minimizes multicultural considerations which results in the input of information by the user that is more consistent and meaningful.

Referring back to the drawings in detail, a more specific preferred embodiment of the system, apparatus and method is a provided for use with the touch screen 10 in entering data onto a screen-generated form 30 that is shown on the screen display 20, the form 30 having multiple points of consideration, or queries. In this preferred embodiment, the electronically-generated form 30 is a Minimum Data Set (MDS) data gathering or collection or observation documentation form that is used for nursing home resident assessment and care screening, which form 30 is shown in the English language and assumes the electronic configuration of a hard-copy form 30, a form that includes data and observation documentation that is essentially mandated by the Medicare program. As alluded to earlier, the MDS form includes a plurality of patient-sensitive considerations, such as Activities of Daily Living (ADL), self-performance difficulty and support needed patterns, patient communication/hearing patterns, mood and behavior patterns, physical functioning and structural problems, special treatments, and so on. In general, each consideration presents a plurality of possible responses and the user populates each specific consideration with an appropriate response. As each consideration is presented to the user, the user may choose a given response.

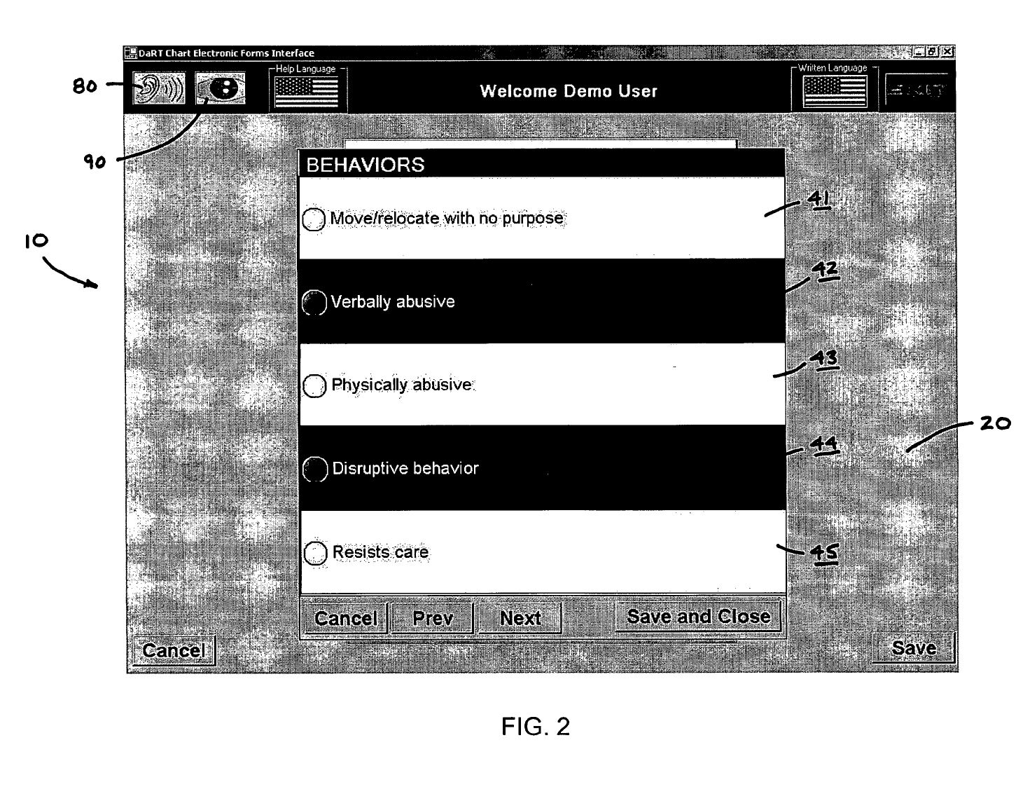

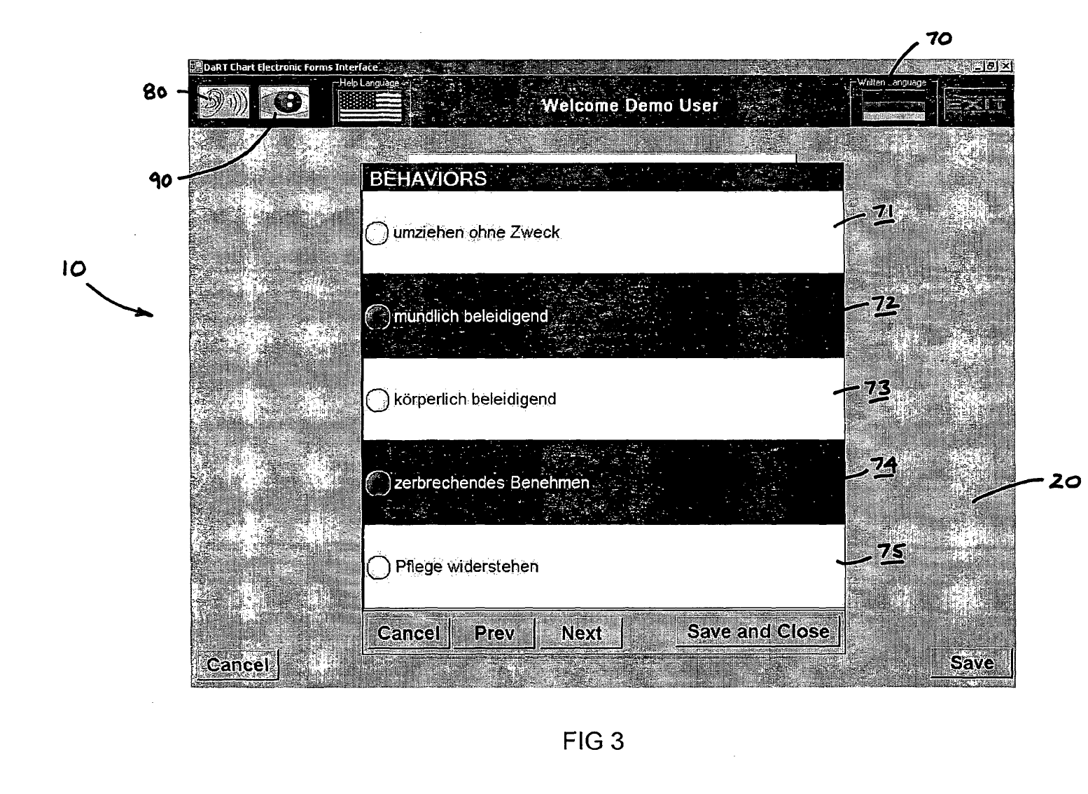

For example, as shown in FIG. 1, each ADL, or point of consideration, 40, 50, 60 poses a question or query, to be answered appropriately by the input user. When the user touches the relevant point of consideration 40, 50, 60, the user's view of that point is maximized such that the user can focus on that ADL. Continuing this example, FIG. 1 illustrates one relevant point of consideration 40 which is entitled “Behavior during shift.” FIG. 2 illustrates the screen display 20 after the user has touched that relevant point of consideration 40. This point, or query, 40 then requires the user to select one of a plurality of possible answers to the query. For example, under this particular query 40, the possible answers are “Move/relocate with no purpose” 41, “Verbally abusive” 42, “Physically abusive” 43, “Disruptive behavior” 44, and “Resists care” 45. It is to be understood that the answers are pre-programmed and presented as a finite number of possible answers to the query. If the user's first language is not English, the user may touch the screen at a virtual push button point 70 to re-generate the display options 40, 41, 42, 43, 44, 45 in another language. As shown in FIG. 3, the user has touched the push button 70 to select options 71, 72, 73, 74, 75 written in the German language. If the user is still tentative about a particular response, the user can touch the screen display at another virtual push button point 80 to have one or more of the response options verbalized through a sound generating means (not shown) such as a speaker. If, after verbalization, the user continues to be tentative, the user can touch yet another virtual push button point 90 on the screen display 20 to have a video vignette 92 displayed on the screen 10 which will further help explain one or more of the response options.

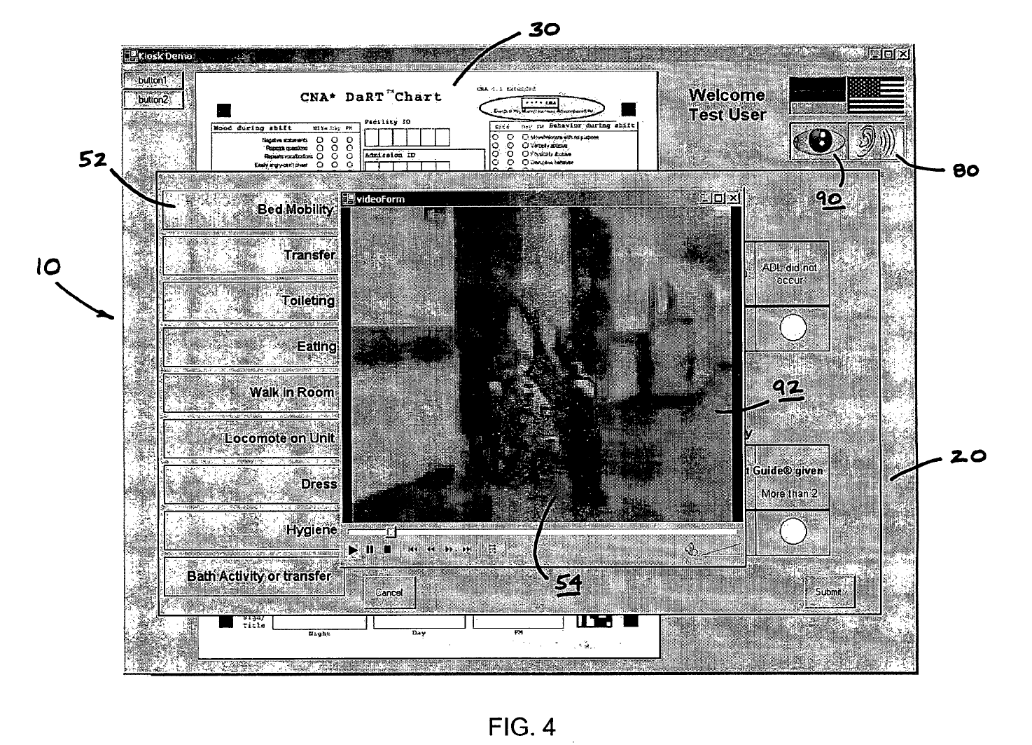

By way of another example, and referring back to FIG. 1, if the query was generally directed to “Physical Assistance Required” 50 and particularly directed to “Bed Mobility” 52, as is shown in FIG. 4, the user may observe a video vignette 54 that displays this activity of “Bed Mobility” 52 to observe a representative scenario wherein that type of activity is being displayed 54 by the caregiver. Having a better understanding of the options available, the user enters the appropriate choice and moves on to the next area of inquiry. Once the electronic MDS data collection form 30 is fully populated, the data, or certain portions of the data, contained within it may be stored as an Electronic Health Record (EHR) and/or forwarded, for example, to other healthcare providers, to healthcare insurers or to Medicare for patient reimbursement purposes.

By taking a multicultural and multimedia approach to this type of data gathering, the gathered information is more accurate and consistent and, thus, more valuable to those who must use the information for various purposes.

Based upon the foregoing, it will be apparent that there has been provided a new, useful and non-obvious computer system, input apparatus and method that facilitates the use of a display in a way that presents multiple words or phrases in a first language and from which the user may select the most appropriate word or phrase in response to the given query; that allows the user to also selectively change the written language for the words or phrases presented such that the same words or phrases are presented in a second or other language, but having essentially the same meaning; that also allows the user to selectively listen to a verbalization and enunciation of the words or phrases in the first, second or other language; that also allows the user to selectively view an animated or video vignette display that represents the meaning of the words or phrases; all of which enhances the user's understanding of the words or phrases and whereby multicultural considerations are minimized and inputted information is entered in a more consistent manner regardless of the cultural and lingual background of the input user.

The principles of this invention having been fully explained in connection with the foregoing, we hereby claim as our invention:

1. A system for acquiring and managing data which comprises
at least one input computer, said at least one input computer having a processing program,
at least one display device, said display device having a visual display and a plurality of defined regions within the visual display for accessing portions of the processing program,
a sound generating means, and
means for operably coupling said at least one input computer, said at least one display device and said sound generating means,
wherein a visually perceptible display of written text on the visual display is provided by the processing program in a first language and a visually perceptible display of other user options is provided by the processing program, said options consisting of at least one from a group comprising
a visually perceptible display of written text in a second or other language,
an audibly perceptible reading of the written text in the first, second and/or other language by use of the sounds generating means,
a video display representative of the message being conveyed by the visually perceptible display of written text and/or the audibly perceptible reading thereof.

2. The data acquisition and management system of claim 1 wherein the display includes a plurality of visually perceptible indicia and the user options are accessed by the user.

3. The data acquisition and management system of claim 2 wherein the display indicia are in the form of visually simulated push buttons that are computer-generated.

4. The data acquisition and management system of claim 3 wherein a plurality of simulated push buttons are presented, one for each of the first, second and other languages.

5. The data acquisition and management system of claim 3 wherein a separate simulated push button is presented for each of the audibly perceptible option and the video display option.

6. The data acquisition and management system of claim 3 wherein the processing program of the at least one input computer provides a display of a virtual form, said form having at least one area that presents the user with written text that includes a query and a plurality of possible responses to the query in the first language.

7. The data acquisition and management system of claim 6 wherein the processing program allows the user to maximize the visual display of and open the at least one query area and the plurality of responses to the query.

8. The data acquisition and management system of claim 7 wherein the processing program allows the user to select at least one simulated button to visually present the maximized visual display of the query and responses to the user in the first, second or other language.

9. The data acquisition and management system of claim 8 wherein the processing program allows the user to select at least one simulated button to audibly present the query and the responses to the user in the first, second and other languages and further allows the user to select at least one simulated button to visually present the query and the responses in a video representation.

10. An apparatus for use with a system for acquiring and managing data, such system including at least one computer having a processing program, at least one display device, said display device having a visual display and a plurality of defined regions within the visual display for accessing portions of the processing program, and a sound generating means, which comprises
an input device,
means for operably coupling the input device with the at least one computer and with the at least one display device and said sound generating means,
wherein a visually perceptible display of written text on the visual display is provided by the processing program in a first language and a visually perceptible display of other user options is provided by the processing program and accessed with use of the input device, said options consisting of at least one from a group comprising
a visually perceptible display of written text in a second or other language,
an audibly perceptible reading of the written text in the first, second and/or other language by use of the sounds generating means,
a video display representative of the message being conveyed by the visually perceptible display of written text and/or the audibly perceptible reading thereof.

11. The apparatus of claim 10 wherein the display includes a plurality of visually perceptible indicia and the user options are accessed by use of the input device by the user.

12. The apparatus of claim 11 wherein the display indicia are in the form of visually simulated push buttons that are computer-generated.

13. The apparatus of claim 12 wherein a plurality of simulated push buttons are presented, one for each of the first, second and other languages.

14. The apparatus of claim 12 wherein a separate simulated push button is presented for each of the audibly perceptible option and the video display option.

15. The apparatus of claim 12 wherein the processing program of the at least one computer provides a display of a virtual form, said form having at least one area that presents the user with written text that includes a query and a plurality of possible responses to the query in the first language.

16. The apparatus of claim 15 wherein the processing program allows the user to maximize the visual display of and open the at least one query area and the plurality of responses to the query.

17. The apparatus of claim 16 wherein the processing program allows the user to select at least one simulated button to visually present the maximized visual display of the query and responses to the user in the first, second or other language.

18. The apparatus of claim 17 wherein the processing program allows the user to select at least one simulated button to audibly present the query and the responses to the user in the first, second and other languages and further allows the user to select at least one simulated button to visually present the query and the responses in a video representation.

19. A method for acquiring and managing data which comprises the steps of
providing at least one input computer, said at least one input computer having a processing program,
providing at least one display device, said display device having a visual display and a plurality of defined regions within the visual display for accessing portions of the processing program,
providing sound generating means, and
operably coupling said at least one input computer, said at least one display device and said sound generating means,
wherein a visually perceptible display of written text on the visual display is provided by the processing program in a first language,
providing a visually perceptible display of other user options on the visual display, said options consisting of at least one from a group comprising
a visually perceptible display of written text in a second or other language,
an audibly perceptible reading of the written text in the first, second and/or other language through use of the sound generating means,
a video display representative of the message being conveyed by the visually perceptible display of written text and/or the audibly perceptible reading thereof.

20. The data acquisition and management method of claim 19 wherein user options providing step further includes the steps of providing a plurality of visually perceptible indicia and accessing the user options via the indicia.

21. The data acquisition and management method of claim 20 wherein the display indicia are visually replicated in the form of push buttons that are computer-generated.

22. The data acquisition and management method of claim 21 wherein a plurality of simulated push buttons are presented, one for each of the first, second and other languages.

23. The data acquisition and management method of claim 21 wherein a separate simulated push button is presented for each of the audibly perceptible option and the video display option.

24. The data acquisition and management method of claim 21 wherein the visually perceptible display of written text is a virtual form, said form having at least one area that presents the user with written text that includes a query and a plurality of possible responses to the query in the first language.

25. The data acquisition and management method of claim 24 including the step of allowing the user to maximize the visual display of and to open the at least one query area and the plurality of responses to the query.

26. The data acquisition and management method of claim 25 including the step of allowing the user to select at least one simulated button to visually present the maximized visual display of the query and responses to the user in the first, second or other language.

27. The data acquisition and management method of claim 26 including the steps of allowing the user to select at least one simulated button to audibly present the query and the responses to the user in the first, second and other languages and allowing the user to select at least one simulated button to visually present the query and the responses in a video representation.
